(19) United States
(12) Patent Application Publication
(10) Pub. No.: US 2017/0243511 A1
(43) Pub. Date: Aug. 24, 2017

(54) FITNESS TRAINING TOOL

(71) Applicant: DAVID ANGELO BELSITO, Oakville (CA)

(72) Inventor: DAVID ANGELO BELSITO, Oakville (CA)

(21) Appl. No.: 15/049,449

(22) Filed: Feb. 22, 2016

(51) Int. Cl. G09B 19/00; G06T 11/00; G06K 9/00; G06T 13/40

(52) U.S. Cl. CPC G09B 19/0038; G06T 13/40; G06T 11/001; G06K 9/00342; G06F 3/0482

(57) ABSTRACT

A computer-implemented method can include receiving a first input from a user, obtaining a video file in response to the first input, outputting the video file for display to the user. The first input can be received by a computing device having one or more processors. The first input can be representative of a physical exercise to be performed by the user, the exercise associated with a muscle. The computing device can obtain the video file of an animated human form, an écorché, performing the physical exercise in response to the first input. The computing device can output the video file for display to the user. The display of the at least one muscle of the animated human form in the video file is visually-enhanced relative to other portions of the animated human form in the video file.

### BACKGROUND

1. Field

The present disclosure relates to an apparatus and method intended to be operated by a human user for the purpose of facilitating the conditioning or developing of a muscle of the user by repetitive or continuous activity of the user.

2. Description of Related Prior Art

U.S. Pat. No. 8,529,409 discloses MOBILE PERSONAL FITNESS TRAINING. Systems and methods presented therein generally provide for portable personalized training programs. More specifically, a mobile device (e.g., MP3 players, iPods, video game players, PDAs, cell phones, etc.) may provide to a user of the device a personalized physical fitness training program that enables the user to maintain physical fitness. In this regard, a physical fitness training program may be configured as one or more software modules wherein associated audio and video segments allow a user to view various physical fitness related training routines on the mobile device. The physical fitness training program may operably control these audio and video segments in a manner that allows the user to personalize a physical fitness routine. Such systems and methods may also have advantages and other types of personalized instruction.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method can include receiving a first input from a user, obtaining a video file in response to the first input, outputting the video file for display to the user. The first input can be received by a computing device having one or more processors. The first input can be representative of a physical exercise to be performed by the user. The physical exercise can be associated with at least one muscle of a human body. The computing device can obtain the video file of an animated human form performing the physical exercise in response to the first input. The animated human form can be an écorché. The computing device can output the video file for display to the user. The display of the at least one muscle of the animated human form in the video file is visually-enhanced relative to other portions of the animated human form in the video file.

### BRIEF DESCRIPTION OF THE DRAWINGS

The detailed description set forth below references the following drawings:

FIG. 1 is a functional block diagram of an exemplary computing device according to some implementations of the present disclosure;

FIG. 2 is a first view of a display of the example computing device of FIG. 1 displaying a user interface of a fitness training tool according to some implementations of the present disclosure;

FIG. 3 is a second view of a display of the example computing device of FIG. 1 displaying a user interface of a fitness training tool according to some implementations of the present disclosure;

FIG. 4 is a diagram of a computing system including an exemplary computing device according to some implementations of the present disclosure;

FIG. 5 is a magnified view of a portion of FIG. 4; and

FIG. 6 is a flow diagram of an example method according to some implementations of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiment described below, can provide direction to a user for engaging in a safe exercises. Implementations of the present disclosure can be used by any demographic of user. Implementations of the present disclosure can provides beginners with knowledge of what exercises are appropriate for them at their stage of fitness. Implementations of the present disclosure can be used in a gym. A user can go to the gym with no idea of what they can do and be provided with a full workout plan for that day without having to wait for a trainer. Implementations of the present disclosure can provide more than just two dimensional images displayed on equipment which show little information of how an exercise is completed and which muscles should be engaged.

Implementations of the present disclosure can provide an informational database on resistance training that is readily available to users and easy to access. Implementations of the present disclosure can allow a user to rapidly choose suggested exercises or whole workouts based on their specific needs. Implementations of the present disclosure can provide variations in workout suggestions for members who desire creative changes. Implementations of the present disclosure can provide a thorough understanding of which muscles should be engaged by the user and a step by step guide to achieving proper form for more complex movement sequences. Implementations of the present disclosure can define a futuristic upgrade to a fitness facilities, adding value to the gym and providing more care to members.

Implementations of the present disclosure can allow for the display an animated human form and can allow the form to be rotated and positioned as desired on a display screen. Implementations of the present disclosure can allow for advanced searches based on specific needs and fitness levels. Implementations of the present disclosure can provide multiple variations and workout choices for the user, safety cues and extra tips to accelerate results and achieve goals. Implementations of the present disclosure can provide instruction on advanced and complex movements.

Implementations of the present disclosure can be positioned in fitness facilities in commercial, corporate, municipal and not-for-profit sectors. Benefits of the present disclosure include education, safety, tips, and proper execution for users. Implementations of the present disclosure can detail highly advanced and sport-specific movements such as Olympic lifts and other complex movements.

Implementations of the present disclosure can benefit and appeal to all users of a gym. Implementations of the present disclosure can enhance safety by reducing the likelihood of injury due to lack of education. Implementations of the present disclosure can be cost efficient alternative to a personal trainer. Implementations of the present disclosure can allow users to go to the gym not knowing what to do or in what order and can be able to generate a whole regimen for the day.

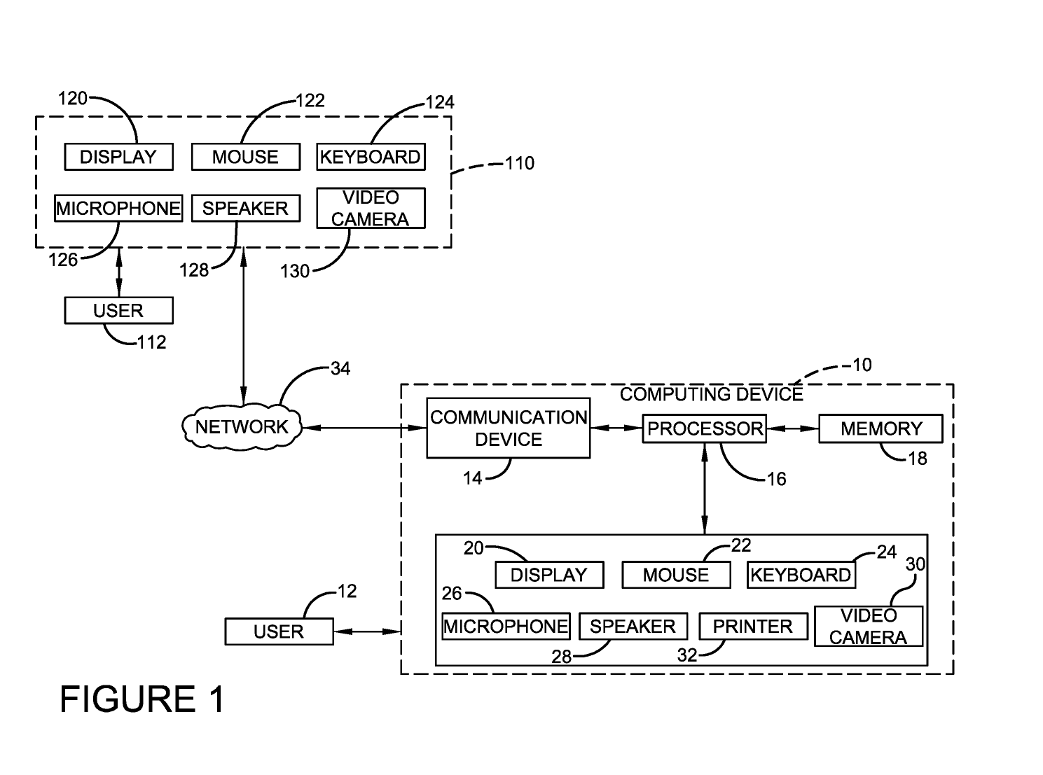

Implementations of the present disclosure can include a computing device. Referring now to FIG. 1, a functional block diagram of one example computing device 10 is illustrated. The computing device 10 can be operated by a user 12. While a single computing device 10 and its associated user 12 and example components are described and referred to hereinafter, it should be appreciated that a computing device according to one or more implementations of the present disclosure can be cooperatively defined by structures that are physically remote from one another, such, for example, a server and smartphone. Examples of the computing device 10 include desktop computers, laptop computers, tablet computers, mobile phones, and smart televisions. In some embodiments, the computing device 10 can be a mobile computing device associated with the user 104. In some embodiments, the computing device 10 can be a server, wherein input from the user 12 is received by the computing device 10 from another computing device associated with the user 12.

The computing device 10 can include a communication device 14, a processor 16, and a memory 18. The computing device 10 can also include a display 20, a mouse 22, a keyboard 24, a microphone 26, a speaker 28, a camera 30, and a printer 32. The display 20, mouse 22, keyboard 24, microphone 26, and camera 30 are referred to herein individually and collectively as “user interface devices.” The user interface devices are configured for interaction with the user 12. The speaker 28 and printer 32 are referred to herein individually and collectively as “peripheral devices.”

The communication device 14 is configured for communication between the processor 16 and other devices, e.g., a user's computing device, via a network 34. The network 34 can include a local area network (LAN), a wide area network (WAN), e.g., the Internet, or a combination thereof. The communication device 14 can include any suitable communication components, such as a transceiver. Specifically, the communication device 14 can transmit requests for input to the user 12 from the processor, can provide response(s) to these requests to the processor 16, and can transmit video files to the user 12 over the network 34. The memory 18 can be configured to store information at the computing device 10, such as video files and exercise options. The exercise options can include a plurality of different exercises defined by different attributes, such as the suitability of the exercise based on a level of fitness of the person performing the exercise, the gender of the person performing the exercise, the muscle utilized during performance of the exercise. Also, each exercise saved in memory can be defined by a video file, wherein the video display by execution of the video file is an animated human form being an écorché performing the exercise. The memory 18 can be any suitable storage medium (flash, hard disk, etc.).

The processor 16 can be configured to control operation of the computing device 10. It should be appreciated that the term “processor” as used herein can refer to both a single processor and two or more processors operating in a parallel or distributed architecture. The processor 16 can be configured to perform general functions including, but not limited to, loading/executing an operating system of the computing device 104, controlling communication via the communication device 14, and controlling read/write operations at the memory 18. The processor 16 can also be configured to perform specific functions relating to at least a portion of the present disclosure including, but not limited to, loading/executing a fitness training tool application and one or more other applications at the computing device 10, initiating/controlling the outputting of a video file to the user 12 through the control of the display 20, including creating and modifying the a user interface, which is described in greater detail below.

In one or more implementations of the present disclosure, the computing device 10 can communicate with remote user interface devices through the network 34. The computing device 10 can receive inputs from a touch screen display 120, a mouse 122, a keyboard 124, a microphone 126, or a camera 130. The computing device 10 can direct outputs to control video images displayed on the display 120 and/or sounds emitted by a speaker 128. The display 120, the mouse 122, the keyboard 124, the microphone 126, the speaker 128, and the camera 130 can be associated with a computing device 110 of a user 112.

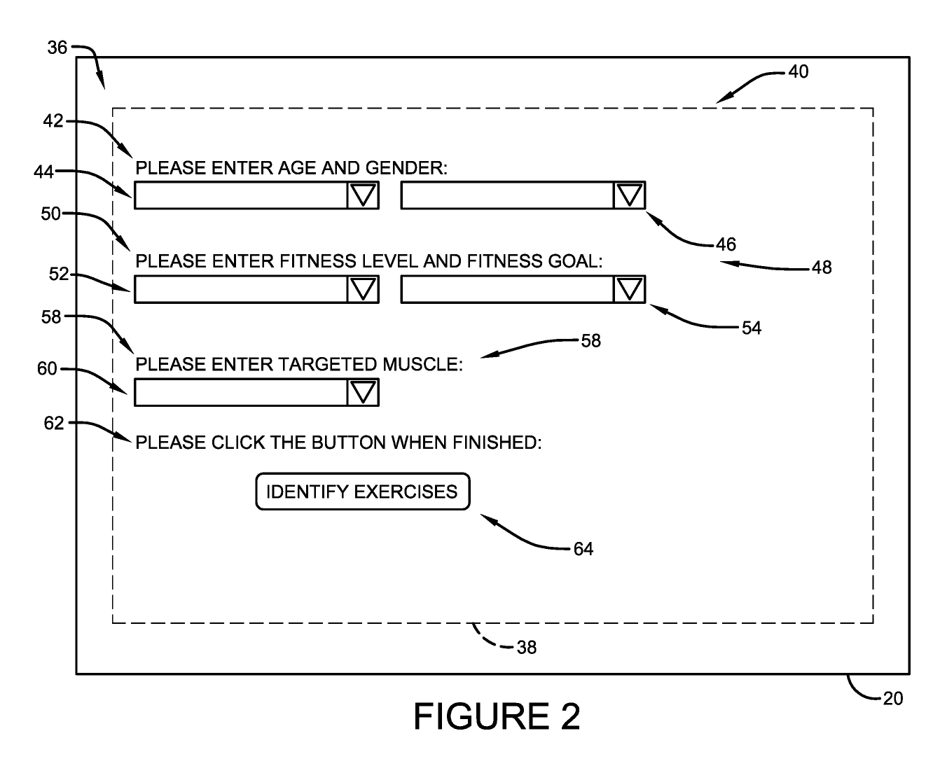

Referring now to FIG. 2, a diagram of the display 20 of the example computing device 10 is illustrated. The computing device 10 can load and execute a fitness training tool application 36, which is illustrated by a user interface displayed in the display area 38 of the display 20. The fitness training tool application 36 may not occupy the entire display area 38, e.g., due to toolbars or other borders (not shown). The fitness training tool application 36 can be configured to initiate a fitness training tool session, which includes displaying prompts to the user 12.

The fitness training tool application 36 executed by the processor 16 can control the display 20 to display a first prompt 40 in the form of text 42 and pull down menus 44, 46. The first prompt 40 can solicit inputs from the user 12 indicative of the age and gender of the user 12. The text 42 can communicate the nature of the inputs sought. The pull down menu 44 can provide genders to select from and the pull down menu 46 can provide a list of possible ages.

The fitness training tool application 36 executed by the processor 16 can control the display 20 to also display a second prompt 48 in the form of text 50 and pull down menus 52, 54. The second prompt 48 can solicit inputs from the user 12 indicative of the fitness level and fitness goal of the user 12. The text 50 can communicate the nature of the inputs sought. The pull down menu 52 can provide various levels of fitness for the user 12 to choose, such as “very fit,” “moderately fit,” and “very unfit.” The pull down menu 54 can provide various fitness goals for the user 12 to choose, such as “fat burning” or “muscle building.”

The fitness training tool application 36 executed by the processor 16 can control the display 20 to also display a third prompt 56 in the form of text 58 and pull down menu 60. The third prompt 56 can solicit inputs from the user 12 indicative of the muscle that the user 12 desires to exercise. The muscle can be defined by a single muscle or by a group of muscles. The text 58 can communicate the nature of the input sought. The pull down menu 60 can provide various levels of fitness for the user 12 to choose, such as “leg,” “thigh,” “arm,” “bicep,” “back,” and “abdomen.”

The fitness training tool application 36 executed by the processor 16 can control the display 20 to also display a fourth prompt 62 in the form of a button 64. When the user 12 has provided the inputs requested by the prompts 40, 48, 56, the user 12 can select the button 64 to transmit the inputs to the processor 16. It is noted that in one or more implementations of the present disclosure, the user 12 can input selections through voice commands transmitted through the microphone 26.

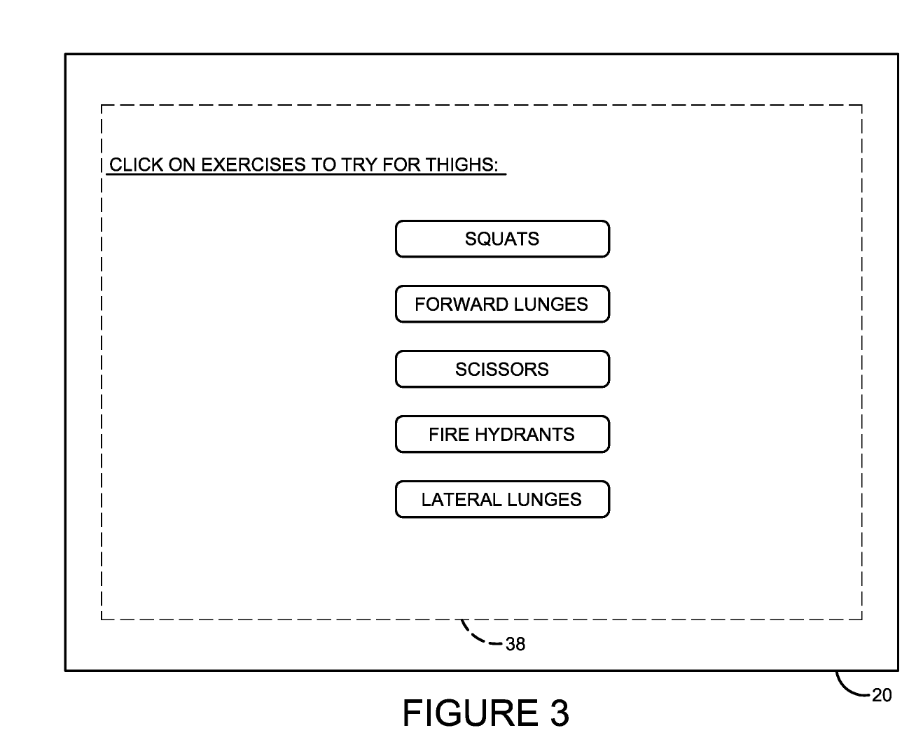

In response to the inputs received from the user 12, the processor 16 can search the records in memory 18 and extract exercises that are consistent with the inputs received from the user 12. As shown in FIG. 3, the processor 16 can control the display 20 to display exercises that are consistent with the inputs received from the user 12, each in the form of button. It is noted that the buttons in FIG. 3 are exemplary and other forms of buttons can be displayed in various implementations of the present disclosure. For example, the buttons could include a thumbnail image of a person engaging in the exercise represented by the button. The user 12 can select any of the exercises to begin the display of a video of the desired exercise being performed. In the example shown in FIG. 3, the user 12 is desiring to exercise a muscle of the thigh.

The fitness training tool application 36 is a computer-implemented method. The computer-implemented method can include receiving a first input from a user 12. The first input can be representative of a physical exercise to be performed by the user 12. The physical exercise can be associated with at least one muscle of a human body. The at least one muscle can be defined by the muscle(s) that are contracting during the physical exercise. For example, the first input can be received by the computing device 10 when the user 12 selects a button as displayed in FIG. 3. In other implementations of the present disclosure, the first input can be a voice input transmitted to the processor 16 by the microphone 26.

The computer-implemented method can include obtaining a video file in response to the first input. The video file can be stored in memory 18 and located in memory 18 by the processor 16. The video file can be indexed or associated with the physical exercise represented by the first input. The processor 16 can obtain the video file in response to the first input. The video file can be of an animated human form performing the physical exercise. The animated human form can be an écorché. An écorché is an image of a human figure with the skin removed to display the musculature. The animated human form can be a completed body or a portion of the human body.

The computer-implemented method can include outputting the video file for display to the user 12. The computing device 10 can output the video file for display to the user 12. The processor 16 can obtain the video file from memory 18 and control the display the video file on the display 20. The user 12 can choose to perform the physical exercise concurrently with the display of the video file or subsequent to the display of the video file. The physical exercise is a movement in which the at least one muscle is contracted and allowed to relax.

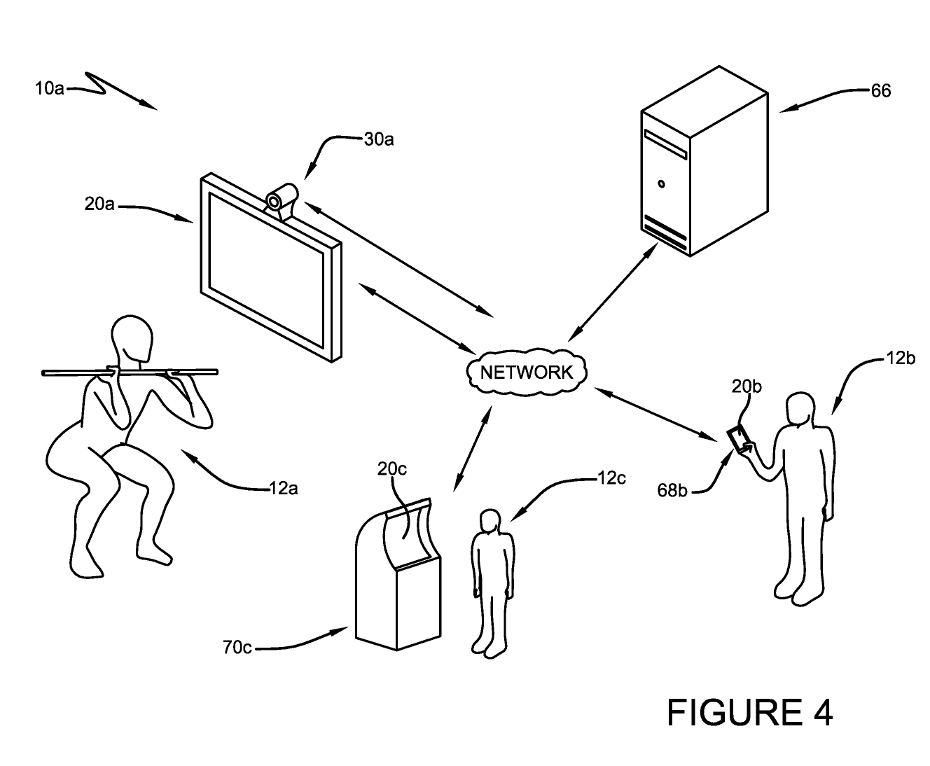

FIG. 4 is a diagram of a computing system including exemplary computing devices 10a, 10b, 10c according to some implementations of the present disclosure. A first computing device 10a can be defined by a server computing device 66 that is physically remote from a user 12a and a display screen 20a that is physically remote from the server computing device 66 but is physically proximate to the user 12a. The display screen 20a can be mounted on a wall at a gym. The user 12a can perform the physical exercise while the video file is being played on the display screen 20a.

A second computing device 10b can be defined by the server computing device 66 that is physically remote from a user 12b and a smartphone 68b that is physically remote from the server computing device 66 but is physically proximate to the user 12b. The server computing device 66 can control a display screen 20b of the smartphone 68b. The user 12b can perform the physical exercise while the video file is being played on the display screen 20b or simply watch and learn the movements of the physical exercise as the video file is being played on the display screen 20b.

A third computing device 10c can be housed in a kiosk 70c that is physically proximate to a user 12c. The computing device 10c can include a display screen 20c. The user 12c can perform the physical exercise while the video file is being played on the display screen 20c or simply watch and learn the movements of the physical exercise as the video file is being played on the display screen 20c. The kiosk 70c can be disposed in a gym. The computing device 10c can be configured to regularly communicate with a server computing device for updates. It is noted that any of the display screens can be touch screens to allow the user to select a first input for transmission to the respective computing device.

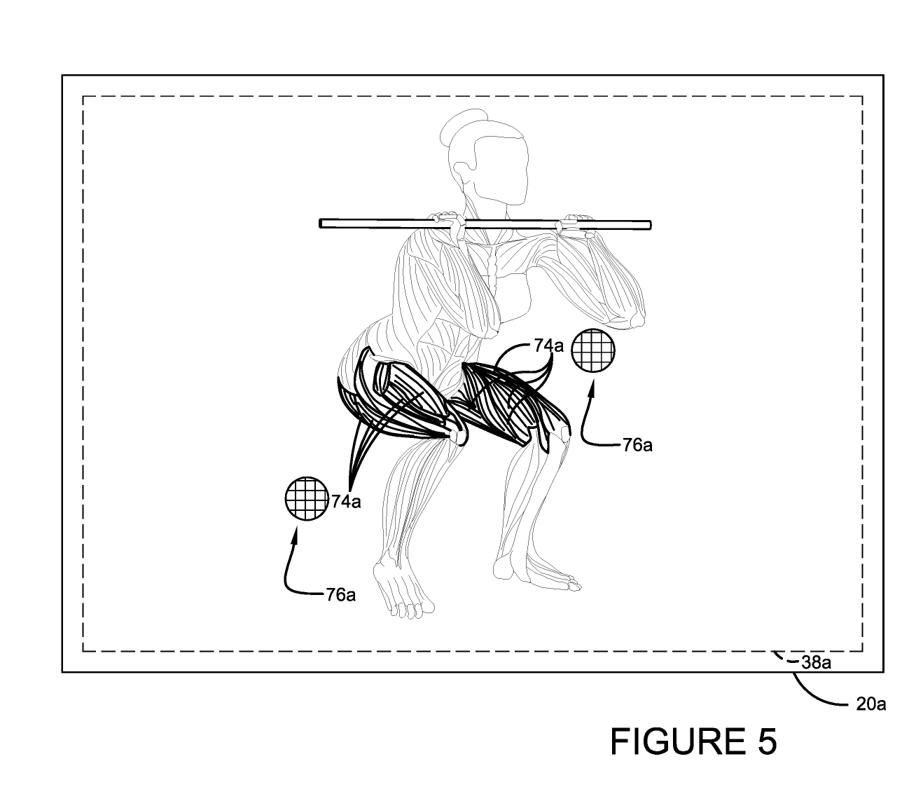

The display of the at least one muscle of the animated human form in the video file is visually-enhanced relative to other portions of the animated human form in the video file. FIG. 5 illustrates the display 20a and the portion 38a of the display 20a in which the video file is displayed to the user 12a. In FIG. 5, an animated human form 72a is shown performing the physical exercise. The animated human form 72a is an écorché. In one or more implementations of the present disclosure, the at least one muscle that is being exercised can be visually-enhanced relative to other portions of the animated human form 72a in the video file by being displayed in a first color wherein at least a majority of a remainder of the animated human form 72a is displayed in a second color different from the first color. As shown in FIG. 5, the animated human form 72a is performing squats (as the user 12a is performing squats as shown in FIG. 4). In this example, the user 12a expressed a desire to exercise a muscle of the thigh, chose the exercise of squats, and the animated human form écorché 72a is performing squats. The muscles of the thigh, referenced at 74a, are being contracted in the video file to perform the exemplary exercise. Drawing symbols referenced at 76a are illustrated to show that the muscles 74a would appear as yellow or gold, in conformance with the United States Patent and Trademark Office Guide for the Preparation of Patent Drawings (June 2002) page A-3-5. Yellow or gold is an exemplary color. The rest of the animated human form 72a can be displayed as another color, such as gray to visually enhance the video display of the muscles 74a.

In one or more implementations of the present disclosure, the at least one muscle 74a that is being exercised can be visually-enhanced relative to other portions of the animated human form 72a in the video file by displaying the at least one muscle 74a in a first color and at least a majority of a remainder of the animated human form 72a in a second color darker than the first color. As in the example, the colors yellow or gold are brighter than dark gray. In other implementations, the muscle 74a could be displayed as light gray or bright red and the remainder of the animated human form 72a could be displayed as dark gray or dull red. In one or more implementations of the present disclosure, the at least one muscle 74a that is being exercised can be visually-enhanced relative to other portions of the animated human form 72a in the video file by displaying the at least one muscle as the largest displayed feature of the animated human form 72a. For example, the processor 16 can be configured to allow the user 12a (or to automatically) zoom in on the animated human form 72a and render the muscle 74a the largest structure displayed. The processor 16 can also be configured to allow the user 12a (or to automatically) pan and rotate the animated human form 72a.

In one or more implementations of the present disclosure, the at least one muscle 74a that is being exercised can be visually-enhanced relative to other portions of the animated human form 72a in the video file by displaying the at least one muscle 74a in a first level of detail and at least a majority of a remainder of the animated human form is displayed in a second level of detail less than the first level of detail. The level of detail of portions of the animated human form 72a can be differentiated by using surface shading. For example, the muscle 74a can be shown with surface shading and surface shading can be omitted from the remainder of the animated human form 72a. The level of detail of portions of the animated human form 72a can be differentiated by using different line thicknesses, narrower or thicker. For example, the muscle 74a can be shown having relatively thicker lines and the remainder of the animated human form 72a can be illustrated with relatively thinner lines.

Referring again to FIG. 4, in one or more implementations of the present disclosure, the computing device 10a can include a camera 30a in electrical communication with the one or more processors of the server computing device 66. The camera 30a can be configured to generate a second input from the user 12a. The second input can be a video stream of the user 12a performing the physical exercise. The second input can be received at the server computing device 66. The server computing device 66 can be configured to determine a current position of the user 12a performing the physical exercise based on the second input. The position of the user 12a can be the user's orientation or the stage of user's movement during the exercise. The server computing device 66 can also be configured to correlate the outputting of the video file such that the animated human form 72a is displayed in the current position of the user 12a. The server computing device 66 can also be configured to determine a pace of performance of the physical exercise by the user 12a based on the second input. The server computing device 66 can also be configured to correlate a rate of the outputting of the video file to the pace. U.S. Patent Application Pub. No. 20130316316 is hereby incorporated by reference for disclosure related to the correlating of a user's movement with a video file output.

It is noted that it one or more embodiments of the present disclosure, the computing device 10 can be configured to store profiles of users. The computing device 10 can be configured to maintain data indicating the user's demographics, preferences, previous exercises, and other information. The computing device 10 can be configured to suggest alternative exercises to the users based on previously-performed exercises to enhance the user's interest in exercising.

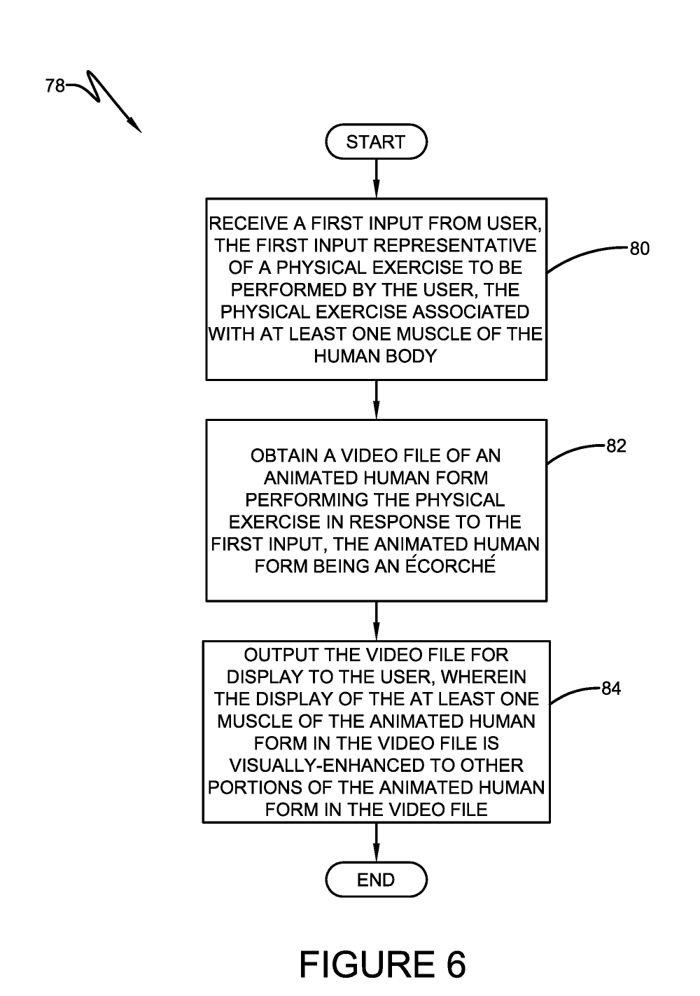

Referring now to FIG. 6, a flow diagram of an example method 78 for assisting a user in fitness training with the fitness training tool application 36 as illustrated. For ease of description, the method 78 will be described in reference to being performed by a computing device 10a, but it should be appreciated that the method 78 can be performed by two or more computing devices operating in a parallel or distributed architecture, and/or any one or more particular components of one or a plurality of computing devices.

At 80, the computing device 10a receives a first input from a user. The first input representative of a physical exercise to be performed by the user. The physical exercise associated with at least one muscle of a human body.

At 82, the computing device 10a obtains a video file of an animated human form performing the physical exercise in response to the first input. The animated human form being an écorché.

At 84, the computing device 10a outputs the video file for display to the user. The display of the at least one muscle of the animated human form in the video file is visually-enhanced relative to other portions of the animated human form in the video file.

It is noted that one or more implementations of the present disclosure could be utilized for chiropractic training. The video files retrieved could show the manipulation of particular muscles of the écorché being manipulated by the chiropractor.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A computer-implemented method, comprising:
receiving, at a computing device having one or more processors, a first input from a user, the first input representative of a physical exercise to be performed by the user, the physical exercise associated with at least one muscle of a human body;
obtaining, at the computing device, a video file of an animated human form performing the physical exercise in response to the first input, the animated human form being an écorché; and
outputting, at the computing device, the video file for display to the user, wherein the display of the at least one muscle of the animated human form in the video file is visually-enhanced relative to other portions of the animated human form in the video file.

2. The computer-implemented method of claim 1 wherein said outputting is further defined as:
outputting, at the computing device, the video file for display to the user, wherein the display the at least one muscle of the animated human form in the video file is visually-enhanced relative to other portions of the animated human form in the video file wherein the at least one muscle is displayed in a first color and at least a majority of a remainder of the animated human form is displayed in a second color different from the first color.

3. The computer-implemented method of claim 1 wherein said outputting is further defined as:
outputting, at the computing device, the video file for display to the user, wherein the display the at least one muscle of the animated human form in the video file is visually-enhanced relative to other portions of the animated human form in the video file wherein the at least one muscle is displayed in a first color and at least a majority of a remainder of the animated human form is displayed in a second color darker than the first color.

4. The computer-implemented method of claim 1 wherein said outputting is further defined as:
outputting, at the computing device, the video file for display to the user, wherein the display the at least one muscle of the animated human form in the video file is visually-enhanced relative to other portions of the animated human form in the video file wherein the at least one muscle is the largest displayed feature of the animated human form.

5. The computer-implemented method of claim 1 wherein said outputting is further defined as:
outputting, at the computing device, the video file for display to the user, wherein the display the at least one muscle of the animated human form in the video file is visually-enhanced relative to other portions of the animated human form in the video file wherein the at least one muscle is displayed in a first level of detail and at least a majority of a remainder of the animated human form is displayed in a second level of detail less than the first level of detail.

6. The computer-implemented method of claim 1 further comprising:
receiving, at the computing device, a second input from the user, the second input being a video stream of the user performing the physical exercise.

7. The computer-implemented method of claim 6 further comprising:
determining, at the computing a device, a current position of the user performing the physical exercise based on the second input.

8. The computer-implemented method of claim 7 further comprising:
correlating, at the computing device, said outputting of the video file such that the animated human form is displayed in the current position.

9. The computer-implemented method of claim 6 further comprising:
determining, at the computing a device, a pace of performance of the physical exercise by the user based on the second input.

10. The computer-implemented method of claim 9 further comprising:
correlating, at the computing device, a rate of said outputting to the pace.

11. A computing device, comprising:
one or more processors; and
a non-transitory, computer readable medium storing instructions that, when executed by the one or more processors, cause the computing device to perform operations comprising:
receiving a first input from a user, the first input representative of a physical exercise to be performed by the user, the physical exercise associated with at least one muscle of a human body;
obtaining a video file of an animated human form performing the physical exercise, the animated human form being an écorché; and
outputting the video file for display to the user, wherein the display the at least one muscle of the animated human form in the video file is visually-enhanced relative to other portions of the animated human form in the video file.

12. The computing device of claim 11 further comprising:
a kiosk housing said one or more processors and said non-transitory, computer readable medium.

13. The computing device of claim 12 further comprising:
a display screen mounted in said kiosk and in electrical communication with said one or more processors to display the video file.

14. The computing device of claim 12 wherein said display screen is further defined as a touch screen.

15. The computing device of claim 11 wherein said computing device is further defined as a server computing device physically remote from the user.

16. The computing device of claim 15 wherein said server computing device is further defined as configured to receive a voice input from a user computing device associated with the user.

17. The computing device of claim 11 further comprising:
a camera in electrical communication with said one or more processors and configured to generate a second input from the user, the second input being a video stream of the user performing the physical exercise.

18. The computing device of claim 17 wherein said non-transitory, computer readable medium storing instructions further causes the computing device to perform an operation comprising:
determining a current position of the user performing the physical exercise based on the second input.

19. The computing device of claim 18 wherein said non-transitory, computer readable medium storing instructions further causes the computing device to perform an operation comprising:
correlating the outputting of the video file such that the animated human form is displayed in the current position.

20. The computing device of claim 19 further comprising:
a display screen physically remote from but in electrical communication with said one or more processors to display the video file.
